(19) United States
(12) Patent Application Publication
(10) Pub. No.: US 2012/0113674 A1
(43) Pub. Date: May 10, 2012

(54) BACKLIGHT MODULE AND DISPLAY APPARATUS

(75) Inventors: Chengming He, Shenzhen (CN); Yanxue Zhang, Shenzhen (CN)

(73) Assignee: SHENZHEN CHINA STAR OPTOELECTRONICS TECHNOLOGY CO., LTD., Guangming New Dist.,Shenzhen, Guangdong (CN)

(21) Appl. No.: 13/000,318

(22) PCT Filed: Dec. 15, 2010
(86) PCT No.: PCT/CN10/79828

§ 371 Date: Apr. 8, 2011

(30) Foreign Application Priority Data
Nov. 9, 2010 (CN) 201010540859.3

(51) Int. Cl. F21V 7/22; F21V 8/00

(52) U.S. Cl. 362/606; 362/611

(57) ABSTRACT

The present invention provides a backlight module and a display apparatus. The backlight module comprises a casing, a light guide plate and at least one light source. The light guide plate is disposed in the casing and includes a light output surface and at least one positioning convex portion. The positioning convex portion protrudes from the light output surface. The light source is disposed at one or more sides of the light guide plate. The present invention can use the positioning convex portion to simplify the assembly structure and process of the display apparatus.

### FIELD OF THE INVENTION

The present invention relates to a backlight module and a display apparatus, and more particularly to a side-light type backlight module and a display apparatus.

### BACKGROUND OF THE INVENTION

Liquid crystal displays (LCDs) have been widely applied in electrical products. Currently, most of LCDs are backlight type LCDs, and comprise a liquid crystal panel and a backlight module. According to the position of the light sources, the backlight module can be classified into a side-light type or a direct-light type, in order to provide LCDs with backlight sources.

Currently, the liquid crystal panel of the LCD is supported on the backlight module by using a plastic frame, and a front frame is used to assemble the liquid crystal panel on the backlight module. However, this assembly method needs more labor and time, and more elements (the plastic frame and the front frame) are also needed for assembly, thereby increasing cost, labor and time for assembling the LCD.

As a result, it is necessary to provide a backlight module and a display apparatus to solve the problems existing in the conventional technologies, as described above.

### SUMMARY OF THE INVENTION

A primary object of the present invention is to provide a backlight module, wherein the backlight module comprises: a casing including at least one engagement extending portion, wherein the engagement extending portion is formed at least one side of the casing; a light guide plate disposed in the casing, wherein the light guide plate includes a light output surface and at least one positioning convex portion, and the positioning convex portion protrudes from the light output surface and the engagement extending portion covers and engages at least the positioning convex portion; and at least one light source disposed at one or more sides of the light guide plate.

A secondary object of the present invention is to provide a display apparatus, wherein the display apparatus comprises a display panel and a backlight module. The backlight module comprises: a casing including at least one engagement extending portion, wherein the engagement extending portion is formed at least one side of the casing; a light guide plate disposed in the casing, wherein the light guide plate includes a light output surface and at least one positioning convex portion, and the positioning convex portion protrudes from the light output surface and the engagement extending portion covers and engages at least the positioning convex portion; and at least one light source disposed at one or more sides of the light guide plate.

In one embodiment of the present invention, the positioning convex portion includes an engagement recess configured to engage a display panel.

In one embodiment of the present invention, the backlight module further comprises at least one optical film disposed above the light output surface of the light guide plate and engaged in the engagement recess of the positioning convex portion.

In one embodiment of the present invention, the engagement extending portion of the casing extends exceeding the positioning convex portion for engaging and contacting with the display panel.

In one embodiment of the present invention, the disposed height of the light source is identical to or less than a distance between the light output surface and a light reflection surface of the light guide plate.

In one embodiment of the present invention, the backlight module further comprises a reflective layer formed on a light reflection surface and the surface of the positioning convex portion of the light guide plate, and exposing a light input side surface and the light output surface of the light guide plate.

In one embodiment of the present invention, the light guide plate is mounted in the casing by screwing or fastening.

In one embodiment of the present invention, two positioning convex portions are formed at both sides of the light guide plate.

In one embodiment of the present invention, the height of the positioning convex portions is larger than a thickness sum of the display panel and the at least one optical film.

In comparison with the conventional display apparatus which needs more elements for assembly, the display apparatus of the present invention can be positioned or inserted on the backlight module simply and rapidly by the positioning convex portion of the light guide plate, thereby significantly simplifying the assembly structure and process of the display apparatus and saving the assembly time and cost thereof.

The structure and the technical means adopted by the present invention to achieve the above and other objects can be best understood by referring to the following detailed description of the preferred embodiments and the accompanying drawings:

### DESCRIPTION OF THE DRAWINGS

FIG. 1 is a schematic diagram showing a backlight module and a display panel according to a first embodiment of the present invention;

FIG. 2 is a three dimensional view showing a casing according to the first embodiment of the present invention;

FIG. 3 is a three dimensional view showing a light guide plate according to the first embodiment of the present invention;

FIG. 4 is a schematic diagram showing a backlight module and a display panel according to a second embodiment of the present invention;

FIG. 5 is a three dimensional view showing a light guide plate according to the second embodiment of the present invention; and

FIG. 6 and FIG. 7 are schematic diagrams showing a backlight module and a display panel according to a third embodiment of the present invention.

### DETAILED DESCRIPTION OF THE PREFERRED EMBODIMENTS

The following embodiments are exemplified by referring to the accompanying drawings, for describing specific embodiments implemented by the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, like reference numerals indicate like components or items.

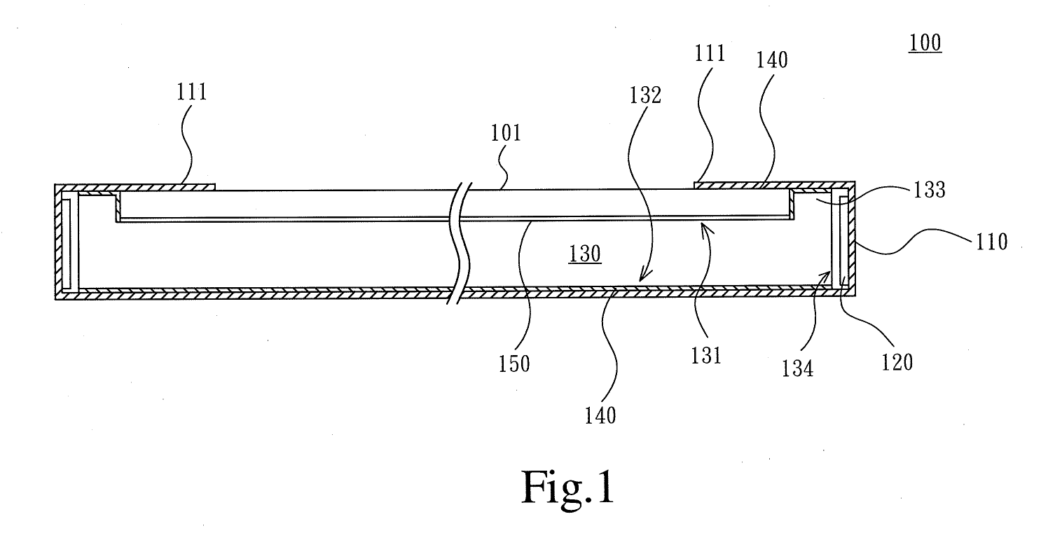

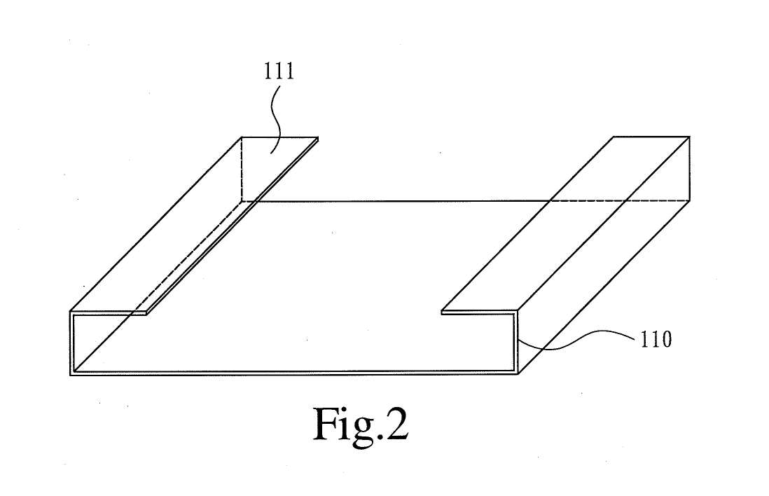

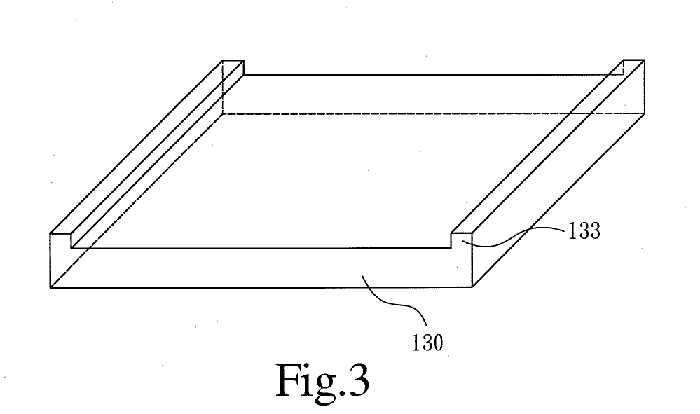

Referring to FIG. 1 through FIG. 3, FIG. 1 is a schematic diagram showing a backlight module and a display panel according to a first embodiment of the present invention, and FIG. 2 is a three dimensional view showing a casing according to the first embodiment of the present invention, and FIG. 3 is a three dimensional view showing a light guide plate according to the first embodiment of the present invention. The backlight module 100 of the present embodiment may be for example a side-light type backlight module and disposed opposite to a display panel 101 (such as a liquid crystal display panel), thereby forming a display apparatus (such as an LCD apparatus). The backlight module 100 comprises a casing 110, at least one light source 120, a light guide plate 130, a reflective layer 140 and at least one optical film 150. The casing 110 is configured to carry the light source 120, the light guide plate 130, the reflective layer 140 and the optical film 150. The at least one light source 120 is disposed at one or more sides of the light guide plate 130 to emit light thereto for guiding light into the display panel 101. The reflective layer 140 may be formed between the casing 110 and the light guide plate 130 for reflecting the light of the light source 120. The optical film 150 is disposed above the light guide plate 130 for optical improvement.

Referring to FIG. 1 and FIG. 2 again, the casing 110 of the present embodiment may be made of an opaque material, such as plastic, metal or any combination material thereof. The casing 110 includes at least one engagement extending portion 111 which extends inside from one side of the casing 110 configured to engage and assemble the light guide plate 130 therein.

Referring to FIG. 1 again, the light source 120 of the present embodiment are, for example, a cold cathode fluorescent lamp (CCFL), a light emitting diodes (LED), an organic light emitting diode (OLED), an electro-luminescence (EL) device, a light bar or any combination thereof.

In one embodiment, the light source 120 may be for example a light bar which includes a circuit broad and a lighting element (such as an LED chip). The circuit broad may be a printed circuit board (PCB) or a flexible printed circuit (FPC). The lighting element is disposed on the circuit broad.

Referring to FIG. 1 and FIG. 3 again, the light guide plate 130 of the present embodiment may be made by the method of injection molding, and the material thereof may be photo-curable resin, polymethylmethacrylate (PMMA) or polycarbonate (PC) for guiding the light of light source 120 toward the liquid crystal display panel 101. The light guide plate 130 includes a light output surface 131, a light reflection surface 132, at least one positioning convex portion 133 and a light input side surface 134. The light output surface 131 is formed on one side of the light guide plate 130 and faces to the liquid crystal display panel 101. The light output surface 131 may include a cloudy surface or a plurality of scattering patterns to uniform light outputted from the light guide plate 130, i.e. the situation of mura is prevented. In one embodiment, the light output surface 131 may include a plurality of protruding structures (not shown) to modify the direction of light, thereby condensing light and enhancing the brightness thereof, wherein the protruding structures may be prism-shaped structures or semicircle-shaped structures. The light reflection surface 132 is formed opposite to the light output surface 131 for reflecting light thereto. In the present embodiment, the light reflection surface 132 of the light guide plate 130 is parallel to the light output surface 131. The light reflection surface 132 may have a plurality of light guiding structures (not shown) formed thereon to guide light to the light output surface 131. The light guiding structures of the light reflection surface 132 may be a continuous V-shaped structure, i.e. V-cut structures, a cloudy surface or scattering patterns, thereby guiding the light of the light source 120 to be outputted from the light output surface 131. The light input side surface 134 is formed on one side or two opposite sides of the light guide plate 130 and corresponding to the light source 120 for allowing the light emitted by the light source 120 to be inputted in the light guide plate 130. The light input side surface 134 may have V-shaped structures (V-cut structures), S-shaped structures or a rough surface structure (not shown) to raise light incidence efficiency and light coupling efficiency. In the embodiment, the light input side surface 134 may be a plane surface vertical to the light reflection surface 132.

Referring to FIG. 1 again, the positioning convex portion 133 is formed at one or more sides of the light guide plate 130 as one piece for positioning and assembling the display panel 101 on the light output surface 131 of the light guide plate 130, wherein the engagement extending portion 111 of the casing 110 covers at least the positioning convex portion 133, i.e. the engagement extending portion 111 extends to the positioning convex portion 133 and engages it. On the other hand, a recess space is formed between a bottom plate of the casing 110 and the engagement extending portion 111. Therefore, the light guide plate 130 can be directly inserted into the recess space of the casing 110, thereby rapidly and simply assembling the light guide plate 130 in the casing 110. In one embodiment, the light guide plate 130 may further be mounted in the casing 110 by screwing or fastening.

In this embodiment, two positioning convex portions 133 are formed at both sides of the light guide plate 130, and thus the display panel 101 can be directly inserted between the two positioning convex portions 133, thereby positioning the display panel 101 above the light output surface 131 of the light guide plate 130. The height of the positioning convex portions 133 is preferably larger than a thickness sum of the display panel 101 and the optical film 150 for simultaneously positioning the display panel 101 and the optical film on the light guide plate 130.

Referring to FIG. 1 again, the reflective layer 140 (or a reflective sheet) of the present embodiment is preferably formed on the surface of the light guide plate 130, such as the light reflection surface 132 and the surface of the positioning convex portion 133, and merely exposes the light input side surface 134 for allowing light to be inputted and the light output surface 131 allowing light to be outputted. The reflective layer 140 may be made of a highly reflective material, such as Ag, Al, Au, Cr, Cu, In, Ir, Ni, Pt, Re, Rh, Sn, Ta, W, Mn, alloy of any combination thereof, white reflective paint with etiolation-resistant and heat-resistant properties or any combination thereof for reflecting light.

Referring to FIG. 1 again, the optical film 150 of the present embodiment may be a diffuser, a prism sheet, a turning prism sheet, a brightness enhancement film (BEF), a dual brightness enhancement film (DBEF), a diffused reflective polarizer film (DRPF) or any combination thereof disposed above the light guide plate 130 and positioned on the light output surface 131 by the positioning convex portions 133 for improving the light outputted from the light guide plate 130.

When assembling the backlight module 100 and the display panel 101 of the present embodiment, firstly, the light source 120, the light guide plate 130, the reflective layer 140 and the optical film 150 can be assembled in the casing 110, wherein the optical film 150 can be directly positioned on the light output surface 131 by the positioning convex portions 133. In this embodiment, the optical film 150 can be directly inserted between the two positioning convex portions 133, thereby positioning the optical film 150 on the light output surface 131. Subsequently, the display panel 101 can be directly positioned on the optical film 150 by the positioning convex portions 133 of the light guide plate 130, thereby achieving the assembly of the display apparatus of the present embodiment.

In this embodiment, when assembling the display panel 101 on the backlight module 100, the engagement extending portion 111 of the casing 110 preferably further extends to a portion of the display panel 101 for simultaneously engaging the display panel 101 in the casing 110. The engagement extending portion 111 of the casing 110 extends exceeding the positioning convex portions 133 for engaging and contacting with the display panel 101, thereby securely assembling the backlight module 100 and the display panel 101 as one piece.

Therefore, with the use of the positioning convex portions 133 of the light guide plate 130, the display panel 101 can be simply and rapidly assembled on the backlight module 100, thereby reducing the elements and weight of the display apparatus. For example, the display panel 101 can directly assembled and positioned on the backlight module 100 without using a front frame or a plastic frame. Accordingly, the assembling time, labor and cost of the display apparatus can be significantly reduced by using the backlight module of the present embodiment.

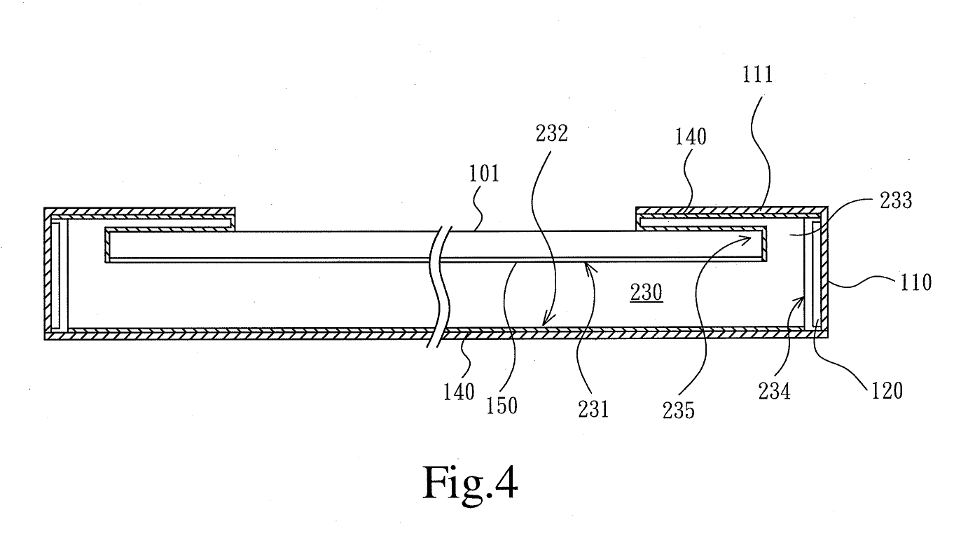

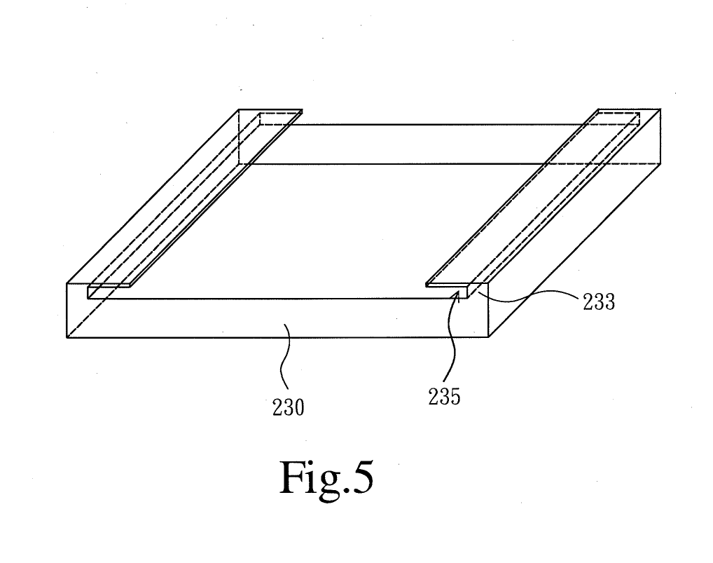

Referring to FIG. 4 and FIG. 5, FIG. 4 is a schematic diagram showing a backlight module and a display panel according to a second embodiment of the present invention, and FIG. 5 is a three dimensional view showing a light guide plate according to the second embodiment of the present invention. Only the difference between the embodiment and the first embodiment will be described hereinafter, and thus the similar portions there-between will be not stated in detail herein. In comparison with the first embodiment, the light guide plate 230 of the second embodiment includes a light output surface 231, a light reflection surface 232, at least one positioning convex portion 233 and a light input side surface 234. The positioning convex portion 233 includes an engagement recess 235 configured to engage the display panel 101. Therefore, when assembling the backlight module 100 and the display panel 101, the display panel 101 and the optical film 150 can be directly inserted in the space formed between the positioning convex portions 233, and engaged in the engagement recess 235, thereby forming the display apparatus. Accordingly, with the use of the light guide plate 230, the backlight module 100 and the display panel 101 can be assembled as one piece, and the structure and assembling process of the display apparatus can be significantly simplified.

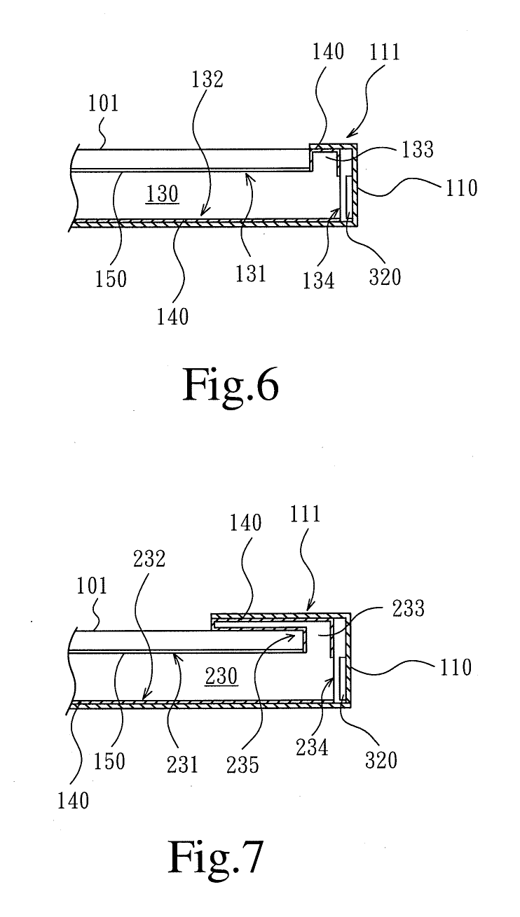

Referring to FIG. 6 and FIG. 7, schematic diagrams showing a backlight module and a display panel according to a third embodiment of the present invention are illustrated. Only the difference between the third embodiment and the first embodiment will be described hereinafter, and thus the similar portions there-between will be not stated in detail herein. In comparison with the first embodiment and the second embodiment, the light source 320 of the third embodiment are disposed at one or more sides of the light guide plate 130, 230, and positioned below the positioning convex portions 133, 233, i.e. the disposed height of the light source 320 is identical to or less than a distance between the light output surface 131, 231 and the light reflection surface 132, 232. Since the light source 320 is directly positioned corresponding to a region between the light output surface 131, 231 and the light reflection surface 132, 232, it is enhanced that the light of the light source 320 can be directly inputted between the light output surface 131, 231 and the light reflection surface 132, 232, thereby reducing the undesired light loss. In this embodiment, referring to FIG. 6 or FIG. 7, the positioning convex portions 133, 233 can selectively include the engagement recess 235.

As described above, in the backlight module and the display apparatus of the present invention can, the display panel can be assembled on the backlight module simply and rapidly by the positioning convex portion of the light guide plate. Furthermore, with the structure of the light guide plate, the present invention can simplify the assembly structure and process of the display apparatus, thereby significantly reducing the assembly time and cost.

The present invention has been described with a preferred embodiment thereof and it is understood that many changes and modifications to the described embodiment can be carried out without departing from the scope and the spirit of the invention that is intended to be limited only by the appended claims.

1. A backlight module characterized in that: the backlight module comprises:
a casing including at least one engagement extending portion, wherein the engagement extending portion is formed at least one side of the casing;
a light guide plate disposed in the casing, wherein the light guide plate includes a light output surface and at least one positioning convex portion, and the positioning convex portion protrudes from the light output surface and includes an engagement recess configured to engage a display panel, and the engagement extending portion of the casing covers and engages at least the positioning convex portion;
at least one light source disposed at one or more sides of the light guide plate; and
at least one optical film disposed above the light output surface of the light guide plate and engaged in the engagement recess of the positioning convex portion.

2. The backlight module according to claim 1, characterized in that: the engagement extending portion of the casing extends exceeding the positioning convex portion for engaging and contacting with the display panel.

3. The backlight module according to claim 1, characterized in that: the disposed height of the light source is identical to or less than a distance between the light output surface and a light reflection surface of the light guide plate.

4. The backlight module according to claim 1, characterized in that: the backlight module further comprises a reflective layer formed on a light reflection surface and the surface of the positioning convex portion of the light guide plate, and exposing a light input side surface and the light output surface of the light guide plate.

5. The backlight module according to claim 1, characterized in that: the light guide plate is mounted in the casing by screwing or fastening.

6. The backlight module according to claim 1, characterized in that: two positioning convex portions are formed at both sides of the light guide plate.

7. The backlight module according to claim 1, characterized in that: the height of the positioning convex portions is larger than a thickness sum of the display panel and the optical film.

8. A backlight module characterized in that: the backlight module comprises:
a casing including at least one engagement extending portion, wherein the engagement extending portion is formed at least one side of the casing;
a light guide plate disposed in the casing, wherein the light guide plate includes a light output surface and at least one positioning convex portion, and the positioning convex portion protrudes from the light output surface and the engagement extending portion covers and engages at least the positioning convex portion; and
at least one light source disposed at one or more sides of the light guide plate.

9. The backlight module according to claim 8, characterized in that: the positioning convex portion includes an engagement recess configured to engage a display panel.

10. The backlight module according to claim 8, characterized in that: the engagement extending portion of the casing extends exceeding the positioning convex portion for engaging and contacting with a display panel.

11. The backlight module according to claim 8, characterized in that: the disposed height of the light source is identical to or less than a distance between the light output surface and a light reflection surface of the light guide plate.

12. The backlight module according to claim 8, characterized in that: the backlight module further comprises a reflective layer formed on a light reflection surface and the surface of the positioning convex portion of the light guide plate, and exposing a light input side surface and the light output surface of the light guide plate.

13. The backlight module according to claim 8, characterized in that: the light guide plate is mounted in the casing by screwing or fastening.

14. The backlight module according to claim 8, characterized in that: two positioning convex portions are formed at both sides of the light guide plate.

15. The backlight module according to claim 8, characterized in that: the height of the positioning convex portions is larger than a thickness sum of the display panel and the optical film.

16. A display apparatus, characterized in that: the display apparatus comprises:
a display panel; and
a backlight module comprising:
a casing including at least one engagement extending portion, wherein the engagement extending portion is formed at least one side of the casing;
a light guide plate disposed in the casing, wherein the light guide plate includes a light output surface and at least one positioning convex portion, and the positioning convex portion protrudes from the light output surface and the engagement extending portion covers and engages at least the positioning convex portion; and
at least one light source disposed at one or more sides of the light guide plate.
